(19) United States
(12) Patent Application Publication
(10) Pub. No.: US 2018/0285831 A1
(43) Pub. Date: Oct. 4, 2018

(54) AUTOMATIC WORK ORDER GENERATION FOR A BUILDING MANAGEMENT SYSTEM

(71) Applicant: Honeywell International Inc., Morris Plains, NJ (US)

(72) Inventors: Jayaprakash Meruva, Bangalore (IN); Rajesh Kulandaivel Sankarapandian, Madurai (IN); Nagarajan Nr, Madurai (IN); Sarath Sasidharan, Trivandrum (IN); Priyanka A, Bangalore (IN)

(21) Appl. No.: 15/476,386

(22) Filed: Mar. 31, 2017

(51) Int. Cl. G06Q 10/00; G06Q 10/10; G05B 23/02

(52) U.S. Cl. CPC G06Q 10/20; G05B 23/0272; G06Q 10/1097

(57) ABSTRACT

Devices, methods, and systems for automatic work order generation for a building management system are described herein. One apparatus includes a memory, and a processor configured to execute executable instructions stored in the memory to receive a notification of a detected fault in a component of a facility, automatically determine whether to generate a work order for the detected fault upon receiving the notification of the detected fault, automatically generate the work order for the detected fault upon determining to generate the work order, and automatically send the generated work order to a user.

### TECHNICAL FIELD

The present disclosure relates to devices, methods, and systems for automatic work order generation for a building management system.

### BACKGROUND

A building management system (BMS) can be used to monitor and/or control a facility (e.g., building). For example, an operator or service technician can use a BMS check and/or set the state of components of the facility, such as, for instance, control components, equipment (e.g., HVAC equipment), devices, networks, areas, and/or spaces of the facility. The operator or technician may also use the BMS to detect faults occurring in the components of the facility.

In previous building management systems, faults in the components of the facility are typically detected by performing periodic maintenance inspections on the components, and/or by alerts or alarms raised by control and/or analytic components of the BMS. Upon a fault being detected, a central operator (e.g., manager) of the BMS can generate a work order for a technician to investigate and fix the fault.

Such previous approaches for detecting faults and generating work orders, however, can be inefficient and/or costly. For example, the large number of components in a facility, especially a large facility, can make manual inspection of the components extremely time consuming. Further, the alerts and/or alarms that are raised may not distinguish between high priority faults (e.g., faults that may have a serious impact if not immediately addressed) and lower priority (e.g., less impactful) faults or false alarms. As such, additional and/or repetitive work may be needed to manually validate and identify a fault as high priority (e.g., to manually determine whether to prioritize and/or generate a work order for the fault). Further, the fixing of a high priority fault may be delayed or missed (e.g., because the technician is busy dealing with a lower priority fault or false alarm).

### BRIEF DESCRIPTION OF THE DRAWINGS

FIG. 1 illustrates an example of a system for automatic work order generation for a building management system in accordance with one or more embodiments of the present disclosure.

FIG. 2 illustrates an example of a work order generation processor for automatic work order generation for a building management system in accordance with one or more embodiments of the present disclosure.

FIG. 3A illustrates a table of different combinations of filtering conditions that can be assigned to fault detection rules and components in accordance with one or more embodiments of the present disclosure.

FIG. 3B illustrates an example application of the different filtering condition combinations illustrated in the table of FIG. 3A.

FIG. 4 illustrates an example of a computing device for automatic work order generation for a building management system in accordance with one or more embodiments of the present disclosure.

### DETAILED DESCRIPTION

Devices, methods, and systems for automatic work order generation for a building management system are described herein. For example, one or more embodiments include a memory, and a processor configured to execute executable instructions stored in the memory to receive a notification of a detected fault in a component of a facility, automatically determine whether to generate a work order for the detected fault upon receiving the notification of the detected fault, automatically generate the work order for the detected fault upon determining to generate the work order, and automatically send the generated work order to a user.

Embodiments of the present disclosure can detect faults in the components of a facility, and generate work orders for the detected faults, in a more efficient and/or less costly manner than previous approaches. For example, embodiments of the present disclosure can automatically (e.g., without user input or instruction) determine whether to generate a work order for a detected fault. For instance, embodiments of the present disclosure can automatically distinguish between high priority faults (e.g., faults that may have a serious impact if not immediately addressed) and lower priority (e.g., less impactful) faults or false alarms, and generate work orders for only high priority faults.

As such, the operator or service technician of the building management system may not have to spend time manually validating a fault or manually determining whether a fault is a high priority fault for which a work order should be generated, as with previous approaches. Rather, the operator or service technician can be confident that if a work order has been generated for a fault, then the fault is a high priority fault that should be addressed. As such, embodiments of the present disclosure can ensure that high priority faults are not missed by the operator or service technician (e.g., because the operator or service technician are not wasting time on low priority faults or false alarms).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

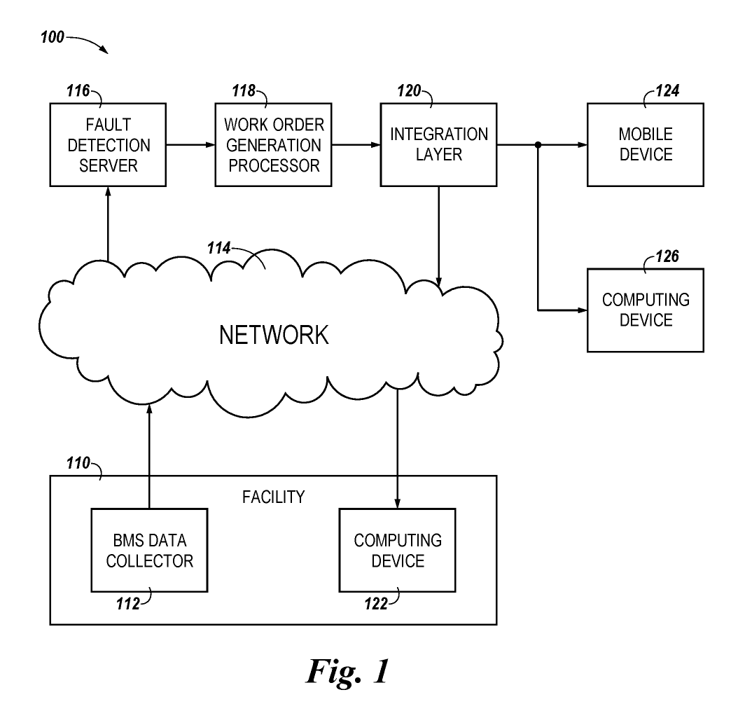

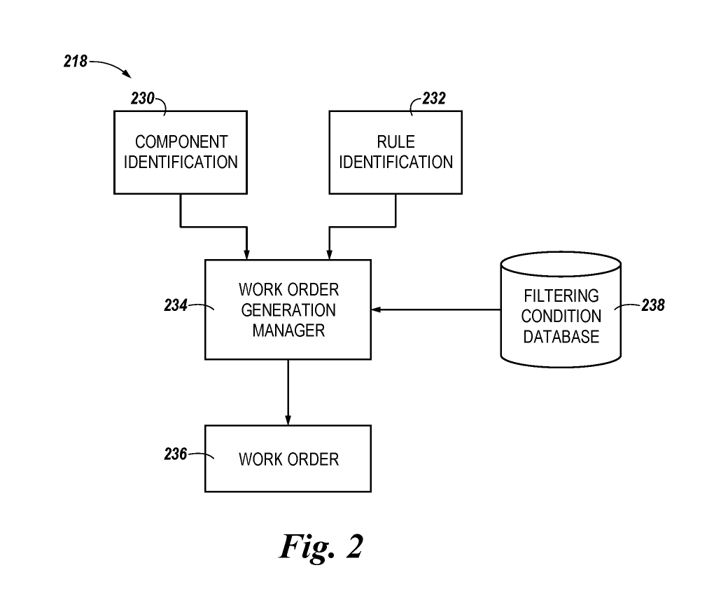

The figures herein follow a numbering convention in which the first digit or digits correspond to the drawing figure number and the remaining digits identify an element or component in the drawing. Similar elements or components between different figures may be identified by the use of similar digits. For example, 118 may reference element “18” in FIG. 1, and a similar element may be referenced as 218 in FIG. 2.

As used herein, “a” or “a number of” something can refer to one or more such things, while “a plurality of” something can refer to more than one such things. For example, “a number of components” can refer to one or more components, while “a plurality of components” can refer to more than one component.

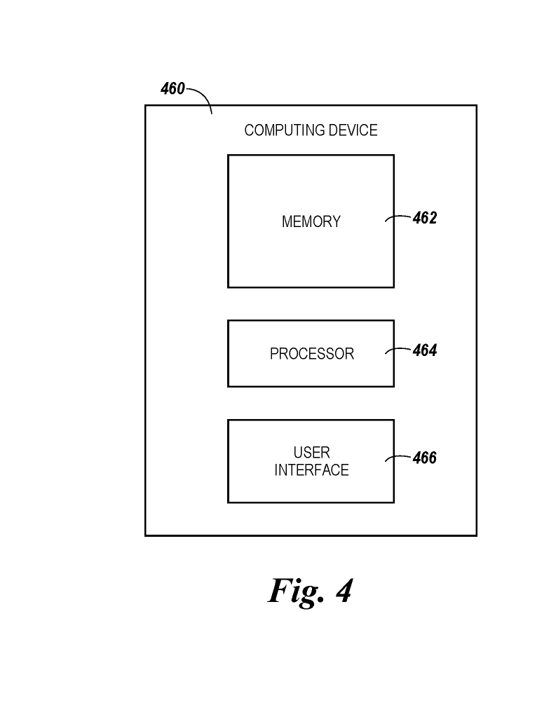

FIG. 1 illustrates an example of a system 100 for automatic work order generation for a building management system in accordance with one or more embodiments of the present disclosure. As shown in FIG. 1, system 100 can include a fault detection server 116, a work order generation processor 118, and an integration layer 120. In some embodiments, fault detection server 116, work order generation processor 118, and/or integration layer 120 can be part of a computing device (e.g., computing device 460 described in connection with FIG. 4) that is part of a centralized management platform.

As shown in FIG. 1, system 100 can include a building management system (BMS) data collector 112 associated with (e.g., on the premises of) a facility 110. Facility 110 can be and/or include a building such as, for instance, a commercial office building, a shopping complex, or an airport, and can be located remotely from the management platform. However, embodiments of the present disclosure are not limited to a particular type of facility.

The BMS can be used (e.g., by a user, such as an operator, manager, and/or technician, for instance) to manage (e.g., monitor and/or control) facility 110. For example, the user can check and/or set the state of control components, equipment (e.g., HVAC equipment such as valves, pumps, fans, etc.), devices, and/or networks associated with the spaces (e.g., areas, rooms, zones, floors, etc.) of facility 110 using the BMS, as will be appreciated by one of skill in the art.

BMS data collector 112 can collect data, such as, for instance, real-time operating data, associated with the BMS. For example, BMS data collector 112 can receive the data directly from controllers, sensors, and/or actuators of the BMS installed in facility 110. Such data can include, for instance, current quantities, statuses, and/or properties of the components (e.g., control components), equipment (e.g., HVAC equipment), devices, networks (e.g., control networks), and/or spaces of facility 110.

As shown in FIG. 1, BMS data collector 112 can send the collected data to fault detection server 116 via network 114 (e.g., fault detection server 116 can receive the data from BMS data collector 112 via network 114). For instance, although not shown in FIG. 1 for clarity and so as not to obscure embodiments of the present disclosure, the management platform can include software, such as open broadcaster software, that can be used to by the management platform (e.g., by fault detection server 116) to receive the data from BMS data collector 112 via network 114.

Network 114 can be a wired or wireless network. For example, network 114 can be a network relationship through which fault detection server 116 and BMS data collector 112 can communicate (e.g., using the management platform software). Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive the data collected by BMS data collector 112, and transmit the received data to fault detection server 116 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

Fault detection server 116 can detect faults occurring in components of facility 110, such as, for instance, heating, ventilation and air conditioning (HVAC) equipment of the facility, based on the data received from BMS data collector 112. For example, fault detection server 116 can analyze the received data to detect faults occurring in the components of facility 110. Embodiments of the present disclosure, however, are not limited to detecting faults in HVAC equipment and/or HVAC components. For example, in some embodiments, fault detection server 116 can detect faults occurring in components of security systems of the facility, such as, for instance, cameras (e.g., video cameras) and/or access control devices (e.g., readers) of the facility, or any other type of integrated BMS components, such as fire detectors and/or alarms, for instance. Further, the data used to detect the faults can be received from BMS data collector 112, as illustrated in FIG. 1, or directly from a control panel on the premises of facility 110 (not shown in FIG. 1 for clarity and so as not to obscure embodiments of the present disclosure).

As used herein, a fault can include and/or refer to a component of facility 110 functioning improperly and/or causing abnormal behavior in facility 110. For example, a fault can include and/or refer to a component of facility 110 breaking down, malfunctioning, or ceasing to operate correctly. As an additional example, a fault can include and/or refer to abnormal (e.g., anomalous) behavior of the component.

In some embodiments, fault detection server 116 can detect faults occurring in the components of facility 110 using fault detection rules. For instance, fault detection server 116 can apply the fault detection rules to the data received from BMS data collector 112 to detect faults occurring in the components of facility 110. The fault detection rules can be, for example, pre-configured rules or adaptive (e.g., dynamic) rules that can change (e.g., update) over time.

Each respective fault detection rule can have a filtering condition associated therewith (e.g., assigned thereto), and each respective component of facility 110 can have a filtering condition associated therewith (e.g., assigned thereto). The filtering condition associated with each respective fault detection rule can depend on (e.g., correspond to), for example, a confidence level associated with that rule (e.g., the confidence level in that rule to accurately detect faults that are actually occurring and not return a false alarm), and/or an importance level associated with that rule (e.g., the priority level of faults detected by that rule). The filtering condition associated with each respective component of facility 110 can depend on (e.g., correspond to), for example, an importance level associated with that component (e.g., a criticality value that reflects how important that component is to the operations of facility 110). The filtering conditions may be pre-configured and stored in a database, as will be further described herein (e.g., in connection with FIG. 2).

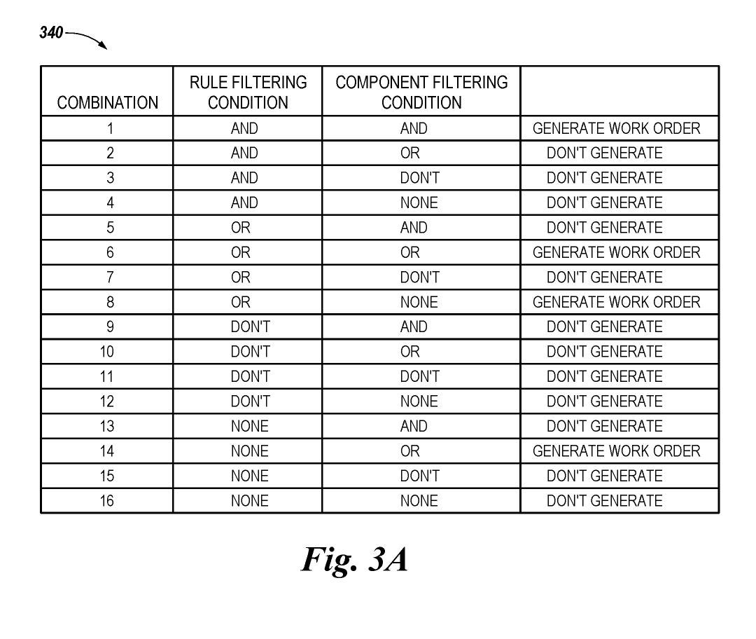

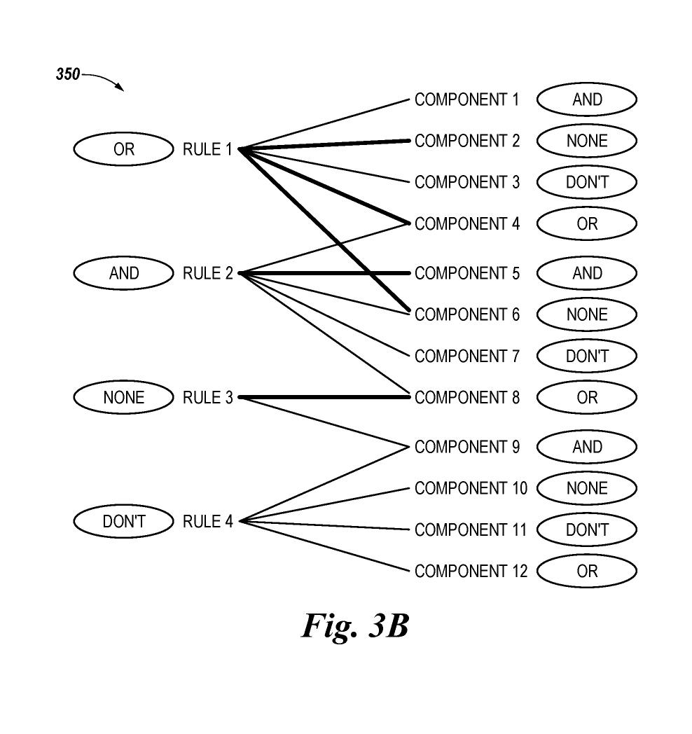

In some embodiments, the filtering condition associated with each respective fault detection rule and the filtering condition associated with each respective component can be a logic function selected from a number of logic functions. Examples of such logic functions will be further described herein (e.g., in connection with FIGS. 3A-3B).

Upon detecting a fault in a component of facility 110, fault detection server 116 can generate a notification (e.g., alert) of the detected fault, and send the notification to work order generation processor 118 (e.g., work order generation processor 118 can receive the notification of the fault from fault detection server 116). For instance, fault detection server 116 can send the notification of the detected fault to work order generation processor 118 via a secure hypertext transfer protocol (https).

Upon receiving the notification of the detected fault, work order generation processor 118 can automatically (e.g., without user input or instruction) determine whether to generate a work order for the detected fault. Work order generation processor 118 can determine whether to generate the work order, for example, based on the fault detection rule that detected the fault and/or the component in which the fault was detected.

For example, work order generation processor 118 can determine whether to generate the work order based on the filtering condition associated with the fault detection rule that detected the fault and/or the filtering condition associated with the component in which the fault was detected. For instance, work order generation processor 118 can determine whether to generate the work order based on the combination of the filtering condition associated with the fault detection rule that detected the fault and the filtering condition associated with the component in which the fault was detected. Examples of such combinations will be further described herein (e.g., in connection with FIGS. 3A-3B).

As such, the determination of whether to generate the work order can be based on a confidence level associated with the detected fault (e.g., the confidence level associated with the fault detection rule that detected the fault that reflects the confidence level that the detected fault is not a false alarm), and/or an importance level associated with the detected fault (e.g., the importance level associated with the fault detection rule that detected the fault that reflects the priority level of the detected fault). Further, the determination of whether to generate the work order can be based on the importance level (e.g., criticality value) associated with the component in which the fault was detected.

By automatically determining whether a work order should be generated for a detected fault in such a manner, work order generation processor 118 can ensure that work orders are only generated for higher priority faults (e.g., faults that may have a serious impact if not immediately addressed). That is, work order generation processor 118 can automatically distinguish between high priority faults and lower priority faults and false alarms, and only generate work orders for the high priority faults (e.g., work orders for lower priority faults and false alarms are not generated).

Upon determining to generate a work order for the detected fault (e.g., upon determining that a work order should be generated for the detected fault), work order generation processor 118 can automatically generate the work order, and automatically send the generated work order to a user (e.g., an operator, manager, and/or service technician). The work order can include, for example, steps and/or tasks to be performed to investigate and/or fix the fault.

Upon determining not to generate a work order for the detected fault (e.g., upon determining that a work order should not be generated for the detected fault), work order generation processor 118 can automatically not generate a work order, such that no work order for the detected fault is sent to the user. As such, work order generation processor 118 can ensure that the user is only receiving work orders for high priority faults, so that the user does not have to waste time trying to manually determine whether a fault for which he or she receives a work order is a high priority fault, or waste time dealing with low priority faults or false alarms.

As an example, work order generation processor 118 can send a generated work order to integration layer 120 via an https, and integration layer 120 can forward the work order to the user. For instance, as shown in FIG. 1, integration layer 120 can send the work order to a computing device 122 of the user that is located at facility 110 via network 114. For instance, although not shown in FIG. 1 for clarity and so as not to obscure embodiments of the present disclosure, the management platform can include a web portal that can be used to by the management platform (e.g., by integration layer 120) to send the work order to computing device 122 at facility 110 via network 114.

As an additional example, integration layer 120 can send the work order to a mobile device (e.g., smart phone) 124 of the user, as shown in FIG. 1. For instance, integration layer 120 can send the work order to a mobile app of mobile device 124. Integration layer 120 can send the work order to mobile device 124, for example, via a wired or wireless network (not shown in FIG. 1 for clarity and so as not to obscure embodiments of the present disclosure).

As an additional example, integration layer 120 can send the work order to a computing device 126 of the user that is located remotely from facility 110. For instance, computing device 126 can be a central control device located at a central control or central command facility. Integration layer 120 can send the work order to computing device 126, for example, via a wired or wireless network (not shown in FIG. 1 for clarity and so as not to obscure embodiments of the present disclosure).

In some instances, a detected fault may cause or trigger multiple problems or issues that may need to be addressed by multiple work orders. As such, work order generation processor 118 can automatically determine, upon determining to generate a work order for a detected fault, whether to generate an additional work order(s) for the detected fault that may be needed to address additional problems or issues caused or triggered by the detected fault that may not be addressed by the original work order. Upon determining to generate the additional work order(s), work order generation processor 118 can automatically generate the additional work order(s) and send the additional work order(s) and send the additional work order(s) to the user, in a manner analogous to the original work order. For example, the additional work order(s) can be sent to the user concurrently (e.g., together) with the original work order.

FIG. 2 illustrates an example of a work order generation processor 218 for automatic work order generation for a building management system in accordance with one or more embodiments of the present disclosure. Work order generation processor 218 can be, for example, work order generate processor 118 previously described in connection with FIG. 1.

As shown in FIG. 2, work order generation processor 218 can include a work order generation manager 234 and a filtering condition database 238. Filtering condition database 236 can include (e.g., store) the filtering conditions associated with (e.g., assigned to) each respective fault detection rule used by fault detection server 116 previously described in connection with FIG. 1. Filtering condition database 236 can also include (e.g., store) the filtering conditions associated with (e.g., assigned to) each respective component of facility 110 previously described in connection with FIG. 1.

As shown in FIG. 2, upon receiving a notification of a detected fault (e.g., from fault detection server 116), an identification 230 of (e.g. an identifier identifying) the component in which the fault was detected and an identification 232 of (e.g., an identifier identifying) the fault detection rule that detected the fault can be input into work order generation manager 234. Upon receiving the identifications 230 and 232 of the component and fault detection rule, respectively, work order generation manager 234 can retrieve the filtering condition associated with that component and the filtering condition associated with that fault detection rule from database 238.

Work order generation manager 234 can then determine whether to generate a work order for the detected fault based on the filtering conditions retrieved from database 238, in a manner analogous to that previously described herein (e.g., in connection with FIG. 1). Upon determining to generate a work order for the detected fault, work order generation manager 234 can generate the work order 236, as illustrated in FIG. 2. Work order 236 can then be sent to a user, as previously described herein (e.g., in connection with FIG. 1).

FIG. 3A illustrates a table 340 of different combinations of filtering conditions that can be assigned to fault detection rules and components in accordance with one or more embodiments of the present disclosure. FIG. 3B illustrates an example application 350 of the different filtering condition combinations illustrated in table 340.

In the example illustrated in FIGS. 3A-3B, one of four different filtering conditions can be assigned to each respective fault detection rule, and one of the four different filtering conditions can be assigned to each respective component. In the example illustrated in FIGS. 3A-3B, the four different filtering conditions can include the logic functions AND, OR, Don't, and None, thereby creating the 16 possible filtering condition combinations illustrated in table 340 (e.g., combination 1 in which the filtering condition assigned to the fault detection rule is AND and the filtering condition assigned to the component is AND, combination 2 in which the filtering condition assigned to the fault detection rule is AND and the filtering condition assigned to the component is OR, combination 3 in which the filtering condition assigned to the fault detection rule is AND and the filtering condition assigned to the component is Don't, etc.).

As shown in table 340, whether a particular filtering condition combination results in a work order being generated depends on the two logic functions that comprise that combination. For example, a work order will be generated when the OR logic function is combined with the None or OR logic function (e.g., combinations 6 and 8 in table 340), but a work order will not be generated when the OR logic function is combined with the AND or Don't logic function (e.g., combinations 5 and 7 in table 340). Further, a work order will not be generated when the Don't logic function is combined with any of the four logic functions (e.g., combinations 9, 10, 11, and 12 in table 340). Further, a work order will be generated when the AND logic function is combined the AND logic function (e.g., combination 1 in table 340), but a work order will not be generated when the AND logic function is combined with any of the other three logic functions (e.g., combinations 2, 3, and 4 in table 340). Further, a work order will be generated when the None logic function is combined the OR logic function (e.g., combination 14 in table 340), but a work order will not be generated when the None logic function is combined with any of the other three logic functions (e.g., combinations 13, 15, and 16 in table 340).

An example application 350 of the different filtering condition combinations illustrated in table 340 is shown in FIG. 3B. In the example illustrated in FIG. 3B, the logic function OR has been assigned to a first fault detection rule (e.g., rule 1), the logic function AND has been assigned to a second fault detection rule (e.g., rule 2), the logic function None has been assigned to a third fault detection rule (e.g., rule 3), and the logic function Don't has been assigned to a fourth fault detection rule (e.g., rule 4). Further, one of these four logic functions has been assigned to 12 different facility components (e.g., the logic function AND has been assigned to components 1, 5, and 9, the logic function None has been assigned to components 2, 6, and 10, the logic function Don't has been assigned to components 3, 7, and 11, and the logic function OR has been assigned to components 4, 8, and 12), as illustrated in FIG. 3B.

Further, in the example illustrated in FIG. 3B, faults have been detected in components 1, 2, 3, 4, and 6 using rule 1, faults have been detected in components 4, 5, 6, 7, and 8 using rule 2, faults have been detected in components 8 and 10 using rule 3, and faults have been detected in components 9, 10, 11, and 12 using rule 4. Based on the logic function assignments illustrated in FIG. 3B and the information from table 340 indicating which filtering condition (e.g., logic function) combinations, the only faults of these that will result in a work order being generated are the faults detected in components 2, 4, and 6 using rule 1, the fault detected in component 5 using rule 2, and the fault detected in component 8 using rule 3, as represented by the thicker lines shown in FIG. 3B. The remaining faults will not result in a work order being generated, as represented by the thinner lines shown in FIG. 3B.

FIG. 4 illustrates an example of a computing device 460 for automatic work order generation for a building management system in accordance with one or more embodiments of the present disclosure. Computing device 460 can be, for example, part of the centralized management platform that includes fault detection server 116, work order generation processor 118, and integration layer 120 previously described in connection with FIG. 1.

Computing device 460 can be, for example, a laptop computer, a desktop computer, or a mobile device (e.g., smart phone, tablet, PDA, etc.). However, embodiments of the present disclosure are not limited to a particular type of computing device.

As shown in FIG. 4, computing device 460 can include a memory 462 and a processor 464. Memory 462 can be any type of storage medium that can be accessed by processor 464 to perform various examples of the present disclosure. For example, memory 462 can be a non-transitory computer readable medium having computer readable instructions (e.g., computer program instructions) stored thereon that are executable by processor 464 to perform automatic work order generation for a building management system in accordance with the present disclosure. That is, processor 336 can execute the executable instructions stored in memory 334 to perform automatic work order generation for a building management system in accordance with the present disclosure.

Memory 462 can be volatile or nonvolatile memory. Memory 462 can also be removable (e.g., portable) memory, or non-removable (e.g., internal) memory. For example, memory 462 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 462 is illustrated as being located in computing device 460, embodiments of the present disclosure are not so limited. For example, memory 462 can also be located internal to another computing resource (e.g., enabling computer readable instructions to be downloaded over the Internet or another wired or wireless connection).

As shown in FIG. 4, computing device 460 can include a user interface 466. A user (e.g., operator) of computing device 460, such as, for instance, an operator, manager, and/or technician of a building management system, can interact with computing device 460 via user interface 466. Further, user interface 466 can receive information from (e.g., input by) the user of computing device 460.

In some embodiments, user interface 466 can be a graphical user interface (GUI) that can include a display (e.g., a screen) that can provide and/or receive information to and/or from the user of computing device 460. The display can be, for instance, a touch-screen (e.g., the GUI can include touch-screen capabilities). As an additional example, user interface 466 can include a keyboard and/or mouse the user can use to input information into computing device 460. Embodiments of the present disclosure, however, are not limited to a particular type(s) of user interface.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for automatic work order generation for a building management system, comprising:
a memory; and
a processor configured to execute executable instructions stored in the memory to:
receive a notification of a detected fault in a component of a facility;
automatically determine whether to generate a work order for the detected fault upon receiving the notification of the detected fault;
automatically generate the work order for the detected fault upon determining to generate the work order; and
automatically send the generated work order to a user.

2. The computing device of claim 1, wherein the processor is configured to execute the instructions to automatically not generate the work order for the detected fault or send the work order to the user upon determining to not generate the work order for the detected fault.

3. The computing device of claim 1, wherein the processor is configured to execute the instructions to automatically determine whether to generate the work order for the detected fault based, at least in part, on a confidence level associated with the detected fault.

4. The computing device of claim 1, wherein the processor is configured to execute the instructions to automatically determine whether to generate the work order for the detected fault based, at least in part, on an importance level associated with the detected fault.

5. The computing device of claim 1, wherein the processor is configured to execute the instructions to automatically determine whether to generate the work order for the detected fault based, at least in part, on an importance level associated with the component in which the fault is detected.

6. The computing device of claim 1, wherein the component of the facility is a component of a heating, ventilation, and air conditioning (HVAC) system of the facility.

7. The computing device of claim 1, wherein the processor is configured to execute the instructions to:
automatically determine, upon determining to generate the work order, whether to generate an additional work order for the detected fault;
automatically generate the additional work order for the detected fault upon determining to generate the additional work order; and
automatically send the additional work order to the user.

8. A method for automatic work order generation for a building management system, comprising:
detecting, by a computing device, a fault occurring in a component of a facility;
automatically determining, by the computing device, whether to generate a work order for the detected fault upon detecting the fault;
automatically generating, by the computing device, the work order for the detected fault upon determining to generate the work order; and
automatically sending, by the computing device, the generated work order to a user.

9. The method of claim 8, wherein the method includes:
receiving data from a building management system associated with the facility; and
detecting the fault occurring in the component of the facility based on the received data.

10. The method of claim 9, wherein the method includes receiving the data from the building management system associated with the facility via a distributed control network.

11. The method of claim 8, wherein sending the generated work order to the user includes sending the generated work order to a computing device of the user at the facility.

12. The method of claim 8, wherein sending the generated work order to the user includes sending the generated work order to a computing device of the user remote from the facility.

13. The method of claim 8, wherein sending the generated work order to the user includes sending the generated work order to a mobile device of the user.

14. A non-transitory computer readable medium having computer readable instructions stored thereon that are executable by a processor to:
detect a fault is occurring in a component of a facility using a fault detection rule;
automatically determine whether to generate a work order for the detected fault based, at least in part, on the fault detection rule used to detect the fault and the component in which the fault is detected;
automatically generate the work order for the detected fault upon determining to generate the work order; and
automatically send the generated work order to a user.

15. The computer readable medium of claim 14, wherein the instructions are executable by the processor to automatically determine whether to generate the work order for the detected fault based, at least in part, on a filtering condition associated with the fault detection rule used to detect the fault and a filtering condition associated with the component in which the fault is detected.

16. The computer readable medium of claim 15, wherein:
the filtering condition associated with the fault detection rule used to detect the fault is a logic function selected from a number of logic functions; and
the filtering condition associated with the component in which the fault is detected is a logic function selected from the number of logic functions.

17. The computer readable medium of claim 15, wherein the filtering condition associated with the fault detection rule used to detect the fault depends on a confidence level associated with the fault detection rule and an importance level associated with the fault detection rule.

18. The computer readable medium of claim 15, wherein the filtering condition associated with the component in which the fault is detected depends on an importance level associated with the component.

19. The computer readable medium of claim 15, wherein the instructions are executable by the processor to retrieve the filtering condition associated with the fault detection rule used to detect the fault and the filtering condition associated with the component in which the fault is detected from a database that includes filtering conditions associated with a plurality of fault detection rules and filtering conditions associated with a plurality of components of the facility.

20. The computer readable medium of claim 15, wherein the instructions are executable by the processor to automatically determine whether to generate the work order for the detected fault based on a combination of the filtering condition associated with the fault detection rule used to detect the fault and the filtering condition associated with the component in which the fault is detected.
